(19) United States
(12) Patent Application Publication
(10) Pub. No.: US 2024/0198646 A1
(43) Pub. Date: Jun. 20, 2024

(54) SUSTAINABLE AIR CUSHION OR MAILER

(71) Applicant: Intertape Polymer Corp., Sarasota, FL (US)

(72) Inventors: John K. Tynan, Fort Huron, MI (US); Nathan Isser, North Street, MI (US)

(73) Assignee: Intertape Polymer Corp., Sarasota, FL (US)

(21) Appl. No.: 18/287,164

(22) PCT Filed: Apr. 14, 2022
(86) PCT No.: PCT/US22/24870

§ 371 Date: Oct. 16, 2023

Related U.S. Application Data
(60) Provisional application No. 63/175,913, filed on Apr. 16, 2021.

(51) Int. Cl. B32B 27/10; B31D 5/00; B32B 3/28; B32B 7/05; B32B 27/22; B32B 27/30; B65D 65/40; B65D 65/46; B65D 81/03; D21H 11/04; D21H 19/20; D21H 23/64; D21H 27/10

(52) U.S. Cl. CPC B32B 27/10; B31D 5/0073; B32B 3/28; B32B 7/05; B32B 27/22; B32B 27/306; B65D 65/403; B65D 65/466; B65D 81/03; D21H 11/04; D21H 19/20; D21H 23/64; D21H 27/10; B31D 2205/0023; B32B 2270/00; B32B 2307/581; B32B 2307/7163; B32B 2439/46; B32B 2553/026; B65D 2565/385

(57) ABSTRACT

A fluid-fillable air cushion or mailer comprising a first layer comprising a repulpable material, a laminate comprising at least two water-soluble material layers, the laminate adjacently affixed to the first layer; and an air fillable portion integral with the laminate, and method of making same are disclosed.

### TECHNICAL FIELD

This disclosure is directed to an air cushion or mailer. More specifically, an air cushion or mailer comprising a fluid-fillable, cellulosic-water-soluble polymer laminate for cushioning material having recyclability and biodegradability. The air cushion or mailer comprises a first layer comprising a repulpable cellulosic material, and a laminate comprising at least two layers of a water-soluble film configured to form a liquid fillable section, the laminate coupled to the first layer for forming a fluid-fillable pocket.

### BACKGROUND

Compressed gas filled type cushioning material, which can absorb external vibration and shock may be made by blowing air, etc. into a sealed bag type sheet material like a balloon has been used in packaging and shipping. The raw material for such sheet material generally has sufficient gas impermeability over environmental pressure for a reasonable time, and a laminated sheet of plastic film, such as polyethylene and nylon, or only plastic sheet, such as nylon, or polyethylene, or a plastic film laminated on paper material, such as kraft paper, may be used. While compressed gas filled type cushioning material made by laminating plastic, etc. onto paper decreases environmental concerns, it does not completely solve the environmental problem as it uses plastic. Separating paper material from the laminated plastic film is extremely difficult, requiring special equipment, and as a result, the paper collection system is not currently equipped to accommodate plastic laminated paper resulting in low sustainability.

A type of common shipping method includes the use of a padded mailer. Padded mailers are generally shipping envelopes that have padded walls to protect their contents. Some padded mailers are constructed of a double wall envelope with paper dunnage between the walls. These mailers are generally made with or of paper envelopes. Another type of mailer has air cushion material lining the inside surfaces of the envelope. These envelopes can be made of paper and plastic. Similar to “peanuts” and air cellular materials, these padded mailers are typically comprised mostly of air, the remainder mass being only partially sustainable. Conventional padded mailers are typically limited to relatively thin padding so that their size is both practical and economic. As a result, the protective capabilities of a conventional compressed gas filled type cushioning material and padded envelope may be limited as well as lacking environmental sustainability.

### SUMMARY

In a first example, a sustainable fluid-fillable air cushion is provided, the cushion comprising a first layer comprising a repulpable material, a second layer comprising a water-soluble material adjacently affixed to the first layer, and an air fillable portion integral with the second layer.

In one aspect, the repulpable material is cellulosic sheet. In another aspect, alone or in combination with any one of the previous aspects, the repulpable material is kraft paper sheet.

In another aspect, alone or in combination with any one of the previous aspects, the water-soluble material layer comprises polyvinyl alcohol (PVOH). In another aspect, alone or in combination with any one of the previous aspects, the PVOH is plasticized. In another aspect, alone or in combination with any one of the previous aspects, the PVOH is plasticized with one or more of polyhydric alcohols, waxes, hydrocarbon oil, mineral oil, polyethylene glycol, propylene glycol, polyethylene oxide, polypropylene oxide, glycerine, mannitol, pentaerythritol, trimethylpropane, starch, chitosan, erythritol, polyethylene amines, ethanolamines, and ionic polymers.

In another aspect, alone or in combination with any one of the previous aspects, the PVOH is a copolymer or blend. In another aspect, alone or in combination with any one of the previous aspects, the copolymer comprises at least one anionic monomer unit. In another aspect, alone or in combination with any one of the previous aspects, the PVOH is a blend of a first PVOH copolymer comprising a first anionic monomer unit, and a second PVOH copolymer comprising a second anionic monomer unit wherein the first anionic monomer unit and the second anionic monomer unit of the blend is the same or different.

In another example, a repulpable mailer comprising the sustainable air cushion as defined in any one of the previous aspects is provided.

In yet another example, a method of forming a sustainable air cushion or mailer is provided, the method comprising contacting a bottom major surface of a repulpable material with a top major surface of a water-soluble material, and creating an fluid-fillable cushion between the repulpable material and the water-soluble material.

In one aspect, the repulpable material is a paper sheet. In another aspect, alone or in combination with any one of the previous aspects, the paper sheet is kraft paper.

In another aspect, alone or in combination with any one of the previous aspects, the water-soluble material comprises polyvinyl alcohol (PVOH). In another aspect, alone or in combination with any one of the previous aspects, the PVOH is plasticized. In another aspect, alone or in combination with any one of the previous aspects, the PVOH is plasticized with one or more of polyhydric alcohols, waxes, hydrocarbon oil, mineral oil, polyethylene glycol, propylene glycol, polyethylene oxide, polypropylene oxide, glycerine, mannitol, pentaerythritol, trimethylpropane, starch, chitosan, erythritol, polyethylene amines, ethanolamines, and ionic polymers.

In another aspect, alone or in combination with any one of the previous aspects, the PVOH is a copolymer or blend. In another aspect, alone or in combination with any one of the previous aspects, the copolymer comprises at least one anionic monomer unit. In another aspect, alone or in combination with any one of the previous aspects, the PVOH is a blend of a first PVOH copolymer comprising a first anionic monomer unit, and a second PVOH copolymer comprising a second anionic monomer unit wherein the first anionic monomer unit and the second anionic monomer unit of the blend is the same or different.

In another aspect, alone or in combination with any one of the previous aspects, the repulpable material and the water soluble material are contacted by solvent coating, extrusion lamination, calendaring, or extrusion coating.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1 depicts a cellulosic-water-soluble polymer laminate aspect of the present disclosure.

FIG. 2 depicts a fluid-fillable, cellulosic-water-soluble polymer laminate or web aspect of the present disclosure.

FIG. 3 depicts an alternate fluid-fillable, cellulosic-water-soluble polymer laminate or web aspect of the present disclosure.

FIG. 4 depicts the fluid-fillable, cellulosic-water-soluble polymer laminate aspect of FIG. 2, in a folded over configuration for providing a mailer aspect of the present disclosure.

FIG. 5 depicts a film/sheet lamination process aspect of the present disclosure.

FIG. 6 depicts an extrusion coating aspect of the present disclosure.

FIG. 7 depicts a calender extrusion process aspect with reinforcing structure of the present disclosure.

FIG. 8 depicts an exemplary mailer aspect of the present disclosure.

### DETAILED DESCRIPTION

The advantage of the presently disclosed air cushion is that while it provides all of the benefits of a traditional polyolefin air pillow, e.g. inflatability, puncture-resistance, and the ability to protect goods from shifting, bruising and breaking, etc., it presents to the user to be made entirely of paper, yet it is inflatable like a traditional polyolefin air pillow. Moreover, after it has served its dunnage purpose, not only can it be subsequently disposed of in the same stream as a corrugated paper box and fully re-pulped, as defined by the FBA test method, it is intuitive to do so because of the presently disclosed air cushion appearance of being essentially paper. The reason this is possible is because the presently disclosed air cushion, in one example, is a composite comprised of a traditional kraft paper layer which has been married to a compounded polyvinyl alcohol (PVOH) layer. The PVOH compound provides good adhesion to the paper, weldability to form an air pillow, and supports inflation and retention of inflated properties, e.g. puncture resistance and minimal deflation, Moreover, it also provides the ability to be completely repulped along with paper.

The presently disclosed air cushion or mailer eliminates or reduces some or all of the disadvantages of conventional (and reinforced) air cushion or mailer structures that employ a polyolefin based or pressure sensitive adhesive and fiber glass, or polyethylene terephthalate (PET), reinforcing yarns, e.g., that are not sufficiently compatible with paper repulping and/or impede the downstream recycled paper-making process, if not filtered and removed from the pulp stream.

As used herein, the term “fluid” refers generally to liquid, gases, and combinations thereof unless specifically stated otherwise. In one example, fluid refers to air at or above atmospheric or ambient pressure.

As used herein, “repulpable” as used in the context of a material, is inclusive of a material substantially or completely derived from pulp. In one aspect, “repulpable material” is inclusive of a material capable of substantially or completely being turned into pulp again. In one example, the presently disclosed air cushion or mailer is at least 60% up to about 99% repulpable, using test procedure A that is specified in the 2013 Fibre Box Association Voluntary Standard for Repulping and Recycling Corrugated Fiberboard Treated to Improve Its Performance in the Presence of Water and Water Vapor (“FBA Standard”). In one example, the air cushion or mailer is at least 65%, 70%, 75%, 80%, 85%, 90%, 95%, 96%, 97%, 98%, or more than 99% repulpable. In one example, the presently disclosed air cushion or mailer is at least 60% up to about 99% repulpable, per the 2013 Fibre Box Association Voluntary Standard for Repulping and Recycling Corrugated Fiberboard Treated to Improve Its Performance in the Presence of Water and Water Vapor (“FBA method”).

In one example, the presently disclosed air cushion or mailer has a yield of at least 60% up to about 99% per the FBA Standard. In one example, the air cushion or mailer has a yield of is at least 65%, 70%, 75%, 80%, 85%, 90%, 95%, 96%, 97%, 98%, or more than 99%.

As used herein, “water-soluble” as used in the context of a material, filament, yarn or ribbon is inclusive of substantial or complete dissolution of the material, film, filament, yarn or ribbon in a repulping environment or process. In one aspect, as used herein, “water-soluble” as used in the context of a material, film, filament, yarn or ribbon is inclusive of substantial or complete dissolution of the material, filament, yarn or ribbon in an aqueous environment at a temperature of about 40-100° C. In another aspect, as used herein, “water-soluble” as used in the context of a material, film, filament, yarn or ribbon is inclusive of substantial or complete dissolution of the material, filament, yarn or ribbon in an aqueous environment of pH greater than about 7.5 and a temperature of about 40-100° C.

As used herein, “derivatives” as used in the context of a material, is inclusive of a physical or chemical modification to the material, such as grafting, co-polymerization, blending, and/or exposing to high-energy radiation sources (i.e., crosslinking or chain scissoring).

In one example, the presently disclosed air cushion or mailer provides an alternative to polyolefin air cushion or mailer by using a polyvinyl alcohol (PVOH) film. In yet another example, the presently disclosed air cushion or mailer provides an alternative to polyolefin air cushion or mailer by using a polyvinyl alcohol film. In one example the PVOH film is machine direction-oriented. Thus, the disclosed air cushion or mailer are an improvement over previous packaging cushions using a non-water soluble plastic film as an air cushion or mailer.

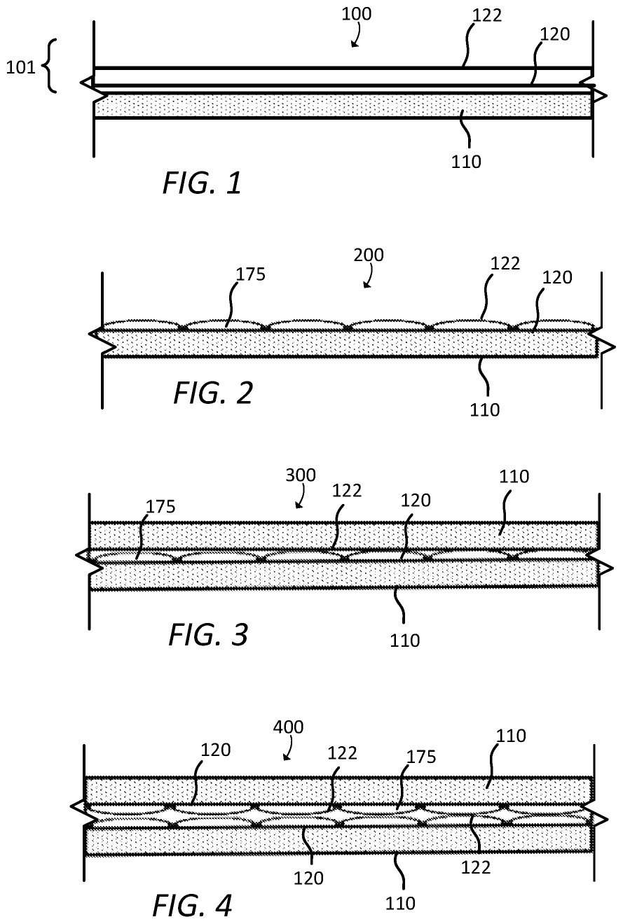

FIG. 1 illustrates a cross-section of air cushion 100 having laminate 101 comprising at least two water-soluble material layers, 120, 122. The repulpable layer 110 and the laminate 101 both have, respectively, a first major (top) surface, a second major (bottom) surface, and a first side and a second side, whereas the first major surface and second major surface extend longitudinally essentially continuously. Cushion 100 is shown with the second major (bottom) surface of laminate 101 affixed to first major (top) surface of repulpable layer 110.

It shall be understood that the air cushion 100, 200 as illustrated in FIGS. 1 and 2 are provided only to emphasize the individual layers of the fluid-fillable web aspects and for purposes of describing the arrangement of layers thereof. It shall also be understood that the depicted individual layers of the air cushion 100, 200 and laminate 101 as illustrated in FIGS. 1 and 2, respectively, are essentially inseparable from each other without irreparably altering the structured layering of the cushion, the repulpable material and/or laminate.

Referring now to FIG. 3, alternative air cushion 300 includes laminate 101 comprising water-soluble material layers 120, 122 sandwiched between two repulpable layers 110. The top surfaces of the repulpable layers 110 are affixed to the opposing major surfaces (top and bottom) of laminate 101. Thus, the laminate 101 has its first major (top) surface, and second major (bottom) surface, sandwiched between and affixed to top major surfaces of paper layers 110.

As used herein, “affixed” when used in the context of the repulpable layer 110 and water-soluble material layer 120, include, but not limited to, extrusion coating, calender lamination, casting, and the like such that physical separation of the repulpable layer 110 and laminate 101 irreparably alters the structural relationship between the layers thereof. Unless specifically indicated, “affixed” when used in the context of the repulpable layer 110 and laminate 101, excludes the use of a partial, continuous, or intermittent adhesive layer or of any adhesive material between the repulpable layer 110 and the laminate 101.

In one example, both the laminate 101 and the repulpable layer 110 are provided as sheet or film and/or brought together to form a liquid fillable air cushion. In one example, the laminate 101 is a cast or blown film of water-soluble material layers 120,122. In one example, laminate 101 is a repulpable layer 110 having affixed thereto at least one water-soluble material layer configured to receive another water-soluble material layer so as to create laminate 101 on repulpable layer 110.

In another example, laminate 101 and/or the repulpable layer 110 is activated prior to forming the laminate, layer, or web. In one example, the top major surface of the laminate 101, or the bottom major surface of the repulpable layer 110 can be activated prior to producing the paper/water-soluble material layer laminate liquid fillable air cushion. Suitable activation processes include corona discharge, flame treatment, spray or adhesive or using coupling agents such as polyamines, amino silanes, amino siloxanes and the like. In one example, activating either laminate 101 or the repulpable layer 110 is performed with brief exposure to water, steam, or other aqueous or humid conditions just prior to affixing the repulpable layer 110 and laminate 101 together.

In one example, the laminate 101 is formed by heating to a softened and/or melted state and extrusion coated, cast or calendered extruded to a bottom major surface of the repulpable layer 110 at least 1 of the water-soluble material layers 102,122. The air cushion 200, 400, as a result of the film/sheet joining, extrusion coating/casting/calendering of the laminate 101 comprising water-soluble material layers 120, 122 to the repulpable layer 110, the cellulosic layer is not easily strippable or separated therefrom. That is, once the cellulosic layer is coated, it is not easy, if not impossible without significant loss of structural integrity, to separate the repulpable layer 110 from the laminate 101. In one example, laminate and receiving surface of water-soluble material layer 120 are treated so as to eliminate or reduce tack of the two surfaces. Such treatment may include dusting, surface roughening and/or use of anti-tack agents in one or both layers 120,122.

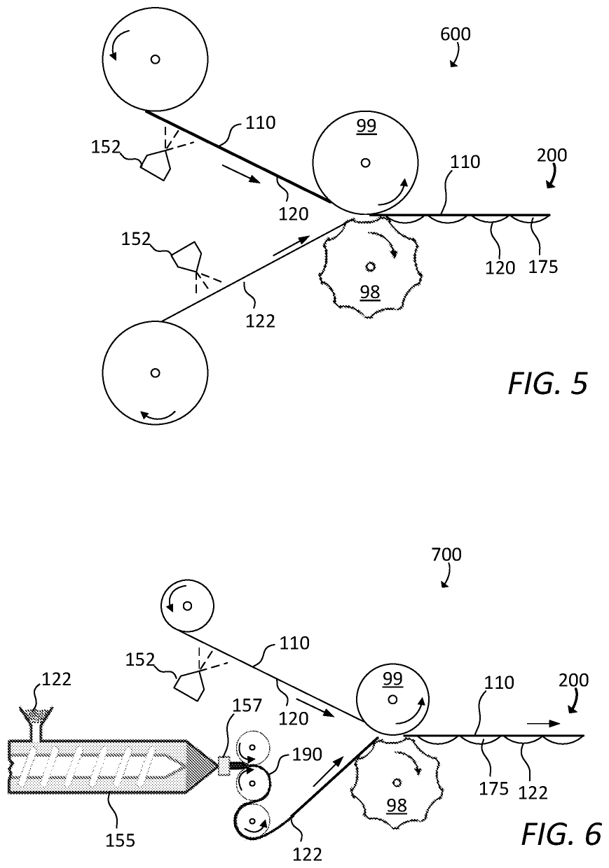

With regard to FIG. 5, an exemplary process 600 for providing the fluid-fillable air cushion 200 of the present disclosure is shown. Top major surface at least one water-soluble material layer 120 of laminate 101 affixed to repulpable layer 110, for example, is provided as a sheet, is affixed to a major surface of another water-soluble material layer, for example, water-soluble material layer 122, also provided as a sheet or film, e.g., blown or cast sheet or film. In one example, the top major surface of the at least one water-soluble material layer 120 is activated prior to introduction to water soluble layer 122 via activating units 152. In one example, top major surface of the at least one water-soluble material layer 120 are activated using an aqueous composition in activating unit 152. In one example, the aqueous composition is water and/or alcohol or a mixture of water and alcohol. Other activating agents can be employed. After top major surface of water soluble layer 120 and top surface of laminate 101 are affixed to each other, the web can be taken up by nip rolls 98 and featured roll 98, where pockets or cavities 175 between water soluble layers of laminate 101 are introduced so as to form fluid-fillable water-soluble and repulpable cellulosic cushion 200. Finished fluid-fillable air cushion 200 or web can be taken up into a roll form for further processing (perforation) or can be continuously processed to introduce air to air cushion or can be sent to end-user for inflation at the point of use.

With reference to FIG. 6, another exemplary process 700 for providing the air cushion 200 of the present disclosure is provided. Repulpable layer 110, for example, provided as a sheet with at least one water-soluble material layer 120 affixed to its top major surface thereof, is joined with at least one water-soluble material layer 122 provided from extruder 155 through a die 157 to a plurality of calender rolls 190 for providing a cast or calendered sheet of the at least one water-soluble material layer 122. In one example, top major surface of water-soluble material layer 120 is activated prior to introduction to nip rolls 99. In one example, top major surface of water-soluble material layer 122 is activated via activating units 152 using an aqueous composition, e.g., water and/or alcohol or mixture thereof. Other activating agents can be employed. Top major surface of at least one water-soluble material layer 120 and top major surface of water-soluble material layer 122 are affixed to each other by nip rolls 98/98, where pockets or cavities 175 between the respective water-soluble material layers 120, 122 are introduced so as to provide fluid-fillable air cushion 200. Finished fluid-fillable air cushion web 200 can be taken up into a roll form for further processing (perforation, flattened) or can be continuously processed to introduce air to air cushion, or sent to an end-user for inflation at point of use.

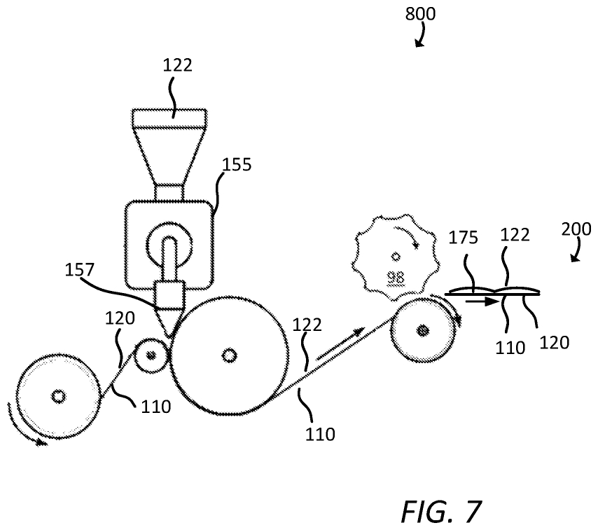

With reference to FIG. 7, another exemplary process 800 for providing the air cushion 200 of the present disclosure is provided. Top major surface of at least one water-soluble material layer 120 affixed to repulpable layer 110, for example, provided as a sheet, is calender extrusion coated with at least one water-soluble material layer 122 from extruder 155 through a die 157. After top major surface of at least one water-soluble material layer 122 and top major surface of water-soluble material layer 120 are affixed to each other and fluid-fillable pockets created via roller 98, the fluid fillable air cushion can be taken up into a roll form for further processing.

The extrusion laminating disposes the innermost lamination layer contiguous to the top major surface of the at least one water-soluble material layer 120 affixed to repulpable layer 110. The method can also include extrusion coating the water-soluble film and laminating the construct onto the repulpable layer 110.

Additives for inclusion in the extrusion or calendering coating or extrusion lamination process or for the water activated tape itself, can include one or more of UV inhibitors, antioxidants, pigments, fillers, and antistatic agents, anti-tack agents, but are not limited thereto. In one example, the top major surface of one or both of the at least one water-soluble material layers 120,122 can be dusted so as to avoid tacking or binding between the films during production and/or during gas filling.

Repulpable layer 110 may be any type of repulpable material, such as cellulosic material. In another example, repulpable layer 110 is printable using thermal or thermal transfer, offset, inkjet, or flexographic (flexo) printing methods. Examples of cellulosic materials include paper, such as, but not limited to, creped paper, non-creped paper, or release paper. In one example, the repulpable layer 110 is a Kraft paper. In another example Creped NBSK (Northern Bleached Softwood Kraft) paper web is used. In one example, a 20 to 57 lb Kraft paper is used. In one example, the repulpable layer 110 surface of the cushion is treated with a repulpable hydrophobic coating, for example, hydrogenated triglycerides of a carbon-chain-length of about 10-20 so as to resist alteration or degradation from exposure to precipitation and other expected environmental conditions experienced during packaging or shipping.

The at least one water-soluble material layer 120, 122 can be any water-soluble polymeric film mono- or multi-layer with sufficient tensile and tear properties to function as a gas fillable air cushion. In one example, the at least one water-soluble material layer 120,122 are the same or a different. The at least one water-soluble material layers 120,122 can be different with respect to one or more of chemical composition of monomers, low percentage of monomers present, molecular weight, viscosity, degree of hydrolysis, water solubility, thickness, etc.

In one example, suitable PVOH polymer films useful in the practice of the present disclosure in forming a sustainable air cushion or mailer have 12-18% crystallinity and is 70% or more hydrolyzed. In another example a suitable PVOH polymer has 30-50% crystallinity and is 80%, 90%, or 99% or more hydrolyzed. In one example, water-soluble films of the present disclosure can be any one or more of commercially available products, for example: 73% hydrolyzed PVOH, Kuraray Poval 505, number average molecular weight 28,000, 88% hydrolyzed PVOH Kuraray Poval 205, Nippon Gohsei GL05, 98% hydrolyzed PVOH, Nippon Gohsei N-300. Polyethylene/Polyvinyl Alcohol Terpolymer, and EXCEVAL (Kuraray LTD of Japan).

Polyvinyl alcohol (PVOH) as used herein can be partially or fully hydrolyzed, where PVOH is a synthetic resin generally prepared by hydrolysis or saponification of polyvinyl acetate. Both fully and partially hydrolyzed PVOH (also referred to as a vinyl alcohol-vinyl acetate copolymer) may be employed in the practice of the present disclosure.

As a representative exemplary example of a water-soluble film suitable for practicing the present disclosure, PVOH or PVOH derivative films (collectively “PVOH films”) are described. PVOH films are produced via melt extrusion and solution casting methods, for example. Typically, in both processes, a highly crystalline PVOH is mixed with a plasticizer to reduce the total amount of crystallinity of the finished, air cushion or mailer soluble film.

In one example, incorporation of high molecular weight plasticizers with the PVOH film reducing large crystalline regions within the film, and/or incorporation of low weight plasticizers reducing the small crystalline regions are used. The plasticizer system can be one, or a combination of conventional plasticizers including polyhydric alcohols, waxes, hydrocarbon oil, mineral oil, polyethylene glycol, propylene glycol, polyethylene oxide, polypropylene oxide, glycerine, mannitol, pentaerythritol, trimethylpropane, starch, chitosan, erythritol, polyethylene amines, ethanolamines, and ionic polymers. Additional components can be added to the PVOH for processing such as nucleating agents, anti-caking agents, anti-slip agents, fillers, such as calcium carbonate, organic and inorganic salts, and the like.

PVOH derivatives include, for example, PVOH blends or copolymers of vinyl alcohol. The PVOH blends or copolymers of vinyl alcohol, for example, can contain at least about 50 wt. %, 55 wt. %, 60 wt. %, 65 wt. %, 70 wt. %, 75 wt. %, 80 wt. %, 85 wt. %, or 90 wt. % and/or up to about 60 wt. %, 70 wt. %, 80 wt. %, 90 wt. %, 95 wt. %, or 99 wt. % of the PVOH. Blends of PVOH can include PVOH polymers of different viscosity, different average molecular weight, different vinyl acetate content, and/or different crystallinity as measured by direct scanning calorimetry (DSC). PVOH blends can include other water-soluble materials, for example, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, polyacrylates and water-soluble acrylate copolymers, methylcellulose, carboxymethyl cellulose salts (e.g., sodium carboxymethyl cellulose, calcium carboxymethyl cellulose), dextrin, ethylcellulose, ethylhydryoxyethyl cellulose (EHEC), hydroxyethyl cellulose (HEC), hydroxyethylmethyl cellulose (HEMC), hydroxypropyl cellulose (HPC), hydroxypropyl methyl cellulose (HPMC), maltodextrin, methyl cellulose (MC), polymethacrylates, and copolymers of PVOH, and mixtures thereof.

Copolymers of vinyl alcohol includes polymers that are derived by the hydrolysis of a copolymer of a vinyl ester, typically vinyl acetate, and another monomer. Copolymers of vinyl alcohol include, for example, one or more carboxylic monomer units, or one or more anionic monomers units, for example, acrylamido methylpropanesulfonic acids (e.g., AMPS comonomers such as 2-acrylamido-1-methylpropanesulfonic acid, 2-acrylamido-2-methylpropanesulfonic acid, 2-methylacrylamido-2-methylpropanesulfonic acid), alkali metal salts thereof (e.g., sodium salts), and combinations thereof. Blends of PVOH and copolymers of vinyl alcohol as described above can be used.

Polyvinyl alcohol (PVOH) blends can be used, for example, comprising a first PVOH copolymer comprising a first anionic monomer unit, and a second PVOH copolymer comprising a second anionic monomer unit. The first anionic monomer unit and the second anionic monomer unit of the blend can be the same or different. The molar or mass amounts of the first and the second PVOH copolymer can be the same or different. The amounts of plasticizer in the first and the second PVOH copolymer can be the same or different. The chemical nature of plasticizer in the first and the second PVOH copolymer can be the same or different. The first PVOH copolymer and the second PVOH copolymer can each independently have a degree of hydrolysis in a range of 75% to 99% (or residual acetate content) or have different degree of hydrolysis. The first PVOH copolymer and the second PVOH copolymer can each independently have a 4% solution viscosity at 20° C. or their viscosities can be different.

Extruded films of the aforementioned PVOH polymers produced from 98-99.9% hydrolyzed PVOH function similarly to EXCEVAL, but dissolve in water at 60° C., rather than 80° C., for example. The first PVOH copolymer and the second PVOH copolymer can each independently have temperature-based water solubilities that are the same or different.

If desired, the PVOH can be compounded into a thermoplastic pellet with a suitable film being produced via melt extrusion. In one example, the PVOH used to make extrudable pellets has less than 0.5% sodium acetate present and/or the extrudable pellets are dried to a level of less than 2% moisture prior to film formation.

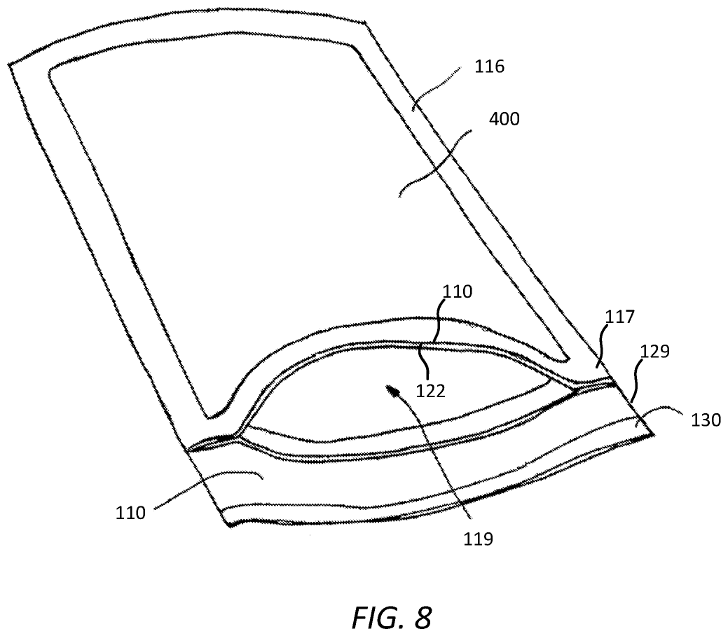

With reference to FIG. 8, a mailer 400 includes water-soluble material layer 120 and repulpable layer 110 formed into a container for receiving goods through opening 119. Using folded over laminate cushion 200 for transport. Opening 119 is created by folding air cushion 200 such that water-soluble material layers 120, 122 face each other, and with repulpable layers 110 facing outwardly on either side. Edges 116 are sealed about the folded structure except at opening 119. In one aspect, water-soluble material layers 120 are sealed together at edges 116, for example, using heat, solvent, or adhesive. In one example, a segment, or length of cushion 200, can be folded in half in the machine direction twice, with three cross-direction folds so as to provide a water-soluble material layer-to-water-soluble material layer interface, and then subsequently creating two additional folds in half simultaneously, thus providing a repulpable surface to repulpable surface interface in the machine direction with two cross-directional folds. Other web-folding techniques can be used to prepare the mailer as presently disclosed with the water-soluble gas-fillable pockets arranged between repulpable layers.

Folded air cushion 200 with sealed edges 116 can provide a suitable mailer 400 article for packaging. In one example, mailer 400 with sealed edges can have an extended portion 129, extending from opening 119 and opening edge 117, where extended portion is configured to fold over and seal the opening. In one example, an adhesive 130 is affixed extended portion 129. In one example, adhesive is water activated. The adhesive 130 can be presented to the extended portion as a continuous or discontinuous film, applied dry or as a solution, such as by spray or electrostatic coating. The adhesive 130 may be any conventional developed adhesive suitable for box sealing or carton sealing (also referred to as packaging adhesive). In one example, the adhesive 130 can be a starch or starch derivative. In one example, the starch, starch derivative or thermoplastic starch is derived from corn, sorghum, wheat, sago, tapioca, legumes, barley, rice, and/or potatoes. In one example, the starch or starch derivative comprises maize, waxy maize, wheat, potato, tapioca, or mixtures thereof. In another example, adhesive 130 is a pressure sensitive adhesive (PSA) with or without a release liner (not shown).

As a result of the construction of the presently disclosed air cushion 100, 200,300,400 the cushion (or mailer) remains with or is included through paper recycling and re-pulping processes with little if any negative impact to operational processes of repulping or downstream new paper-making processes. The presently disclosed air cushion or mailer possesses the physical and structural attributes of a traditional air cushion or mailer carton sealing tape, for example, the ability to be printed, the ability to be perforated, filled, and sealed using conventional air cushion/dunnage equipment. Furthermore, the presently disclosed air cushion or mailer is at least 75%, at least 80%, at least 90%, or at least 95-99% (by weight) re-pulpable, as measured by the Fiber Box Association's (FBA) re-pulpability test method. Moreover, at least 75%, at least 80%, at least 90%, or at least 95-99% of the weight of the air cushion or mailer presently disclosed is available for recycling, e.g., making recycled paper.

While certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures, but may also encompass combinations of elements of the various illustrated embodiments and aspects thereof.

1. A fluid-fillable air cushion comprising:
a first layer comprising a repulpable material;
a laminate comprising at least one water-soluble material layer, the laminate adjacently affixed to the first layer; and
an air fillable portion integral with the laminate.

2. The air cushion of claim 1, wherein the repulpable material is cellulosic sheet.

3. The air cushion of claim 1, wherein the repulpable material is kraft paper sheet.

4. The air cushion of claim 1, wherein the at least one water-soluble material layer comprises polyvinyl alcohol (PVOH).

5. The air cushion of claim 4, wherein the PVOH is plasticized.

6. The air cushion of claim 1, wherein the PVOH is plasticized with one or more of polyhydric alcohols, waxes, hydrocarbon oil, mineral oil, polyethylene glycol, propylene glycol, polyethylene oxide, polypropylene oxide, glycerine, mannitol, pentaerythritol, trimethylpropane, starch, chitosan, erythritol, polyethylene amines, ethanolamines, and ionic polymers.

7. The air cushion of claim 1, wherein the PVOH is a copolymer or blend.

8. The air cushion of claim 1, wherein the copolymer comprises at least one anionic monomer unit.

9. The air cushion of claim 1, wherein the PVOH is a blend of a first PVOH copolymer comprising a first anionic monomer unit, and a second PVOH copolymer comprising a second anionic monomer unit wherein the first anionic monomer unit and the second anionic monomer unit of the blend can be the same or different.

10. A repulpable mailer comprising the sustainable air cushion as defined in claim 1.

11. A method of forming an air cushion or mailer comprising:
contacting a bottom major surface of a repulpable material with a top major surface of a laminate comprising at least one water-soluble material layer; and
creating an fluid-fillable cushion between the at least one water-soluble material layers.

12. The method of claim 10, wherein the repulpable material is a paper sheet.

13. The method of claim 12, wherein the paper sheet is kraft paper.

14. The method of claim 10, wherein the at least one water-soluble material comprises polyvinyl alcohol (PVOH).

15. The method of claim 14, wherein the PVOH is plasticized.

16. The method of claim 14, wherein the PVOH is plasticized with one or more of polyhydric alcohols, waxes, hydrocarbon oil, mineral oil, polyethylene glycol, propylene glycol, polyethylene oxide, polypropylene oxide, glycerine, mannitol, pentaerythritol, trimethylpropane, starch, chitosan, erythritol, polyethylene amines, ethanolamines, and ionic polymers.

17. The method of claim 14, wherein the PVOH is a copolymer or blend.

18. The method of claim 14, wherein the copolymer comprises at least one anionic monomer unit.

19. The method of claim 14, wherein the PVOH is a blend of a first PVOH copolymer comprising a first anionic monomer unit, and a second PVOH copolymer comprising a second anionic monomer unit wherein the first anionic monomer unit and the second anionic monomer unit of the blend can be the same or different.

20. The method of claim 11, wherein the repulpable material and the water soluble material are contacted by solvent casting, extrusion lamination, calendaring, or extrusion coating.
